(19) United States
(12) Patent Application Publication
(10) Pub. No.: US 2010/0293361 A1
(43) Pub. Date: Nov. 18, 2010

(54) ELECTRONIC DEVICE AND METHOD FOR CONTROLLING ELECTRONIC DEVICE

(75) Inventor: Shigeru SHIBATA, Tokyo (JP)

Correspondence Address: HOLTZ, HOLTZ, GOODMAN & CHICK PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 12/758,159

(22) Filed: Apr. 12, 2010

(30) Foreign Application Priority Data
May 18, 2009 (JP) P2009-119694

(51) Int. Cl. G06F 1/24; G06F 1/26

(52) U.S. Cl. 713/1; 713/300

(57) ABSTRACT

An electronic device including a power key, a time counter which measures how long the power key is continuously pressed, and first and second controllers is provided. The first controller can be suspended while performing a software process upon identifying a length of time measured by the time counter as not being longer than a first given time length, and can be in control so that a power supply is turned off upon identifying the measured length of time as being longer than a second given time length which is longer than the first given time length and as not being longer than a third given time length which is longer than the second given time length. The second controller can send a resetting signal to the first controller upon identifying the measured length of time as being longer than the third given time length.

### CROSS REFERENCE TO RELATED APPLICATIONS

This application is based upon and claims the benefit of priority from the prior Japanese Patent Application No. 2009-119694 filed on May 18, 2009; the entire contents of which are incorporated herein by reference.

### BACKGROUND OF THE INVENTION

1. Field of the Invention

The present invention relates to an electronic device and a method for controlling an electronic device, and in particular an electronic device configured to perform a software process.

2. Description of the Related Art

An electronic device having a processor, etc. which performs a software process sometimes freezes (causes hang-up) as the software process runs out of control or becomes uncontrollable. Such a phenomenon is caused by insufficient resources, e.g., to perform a software process of an excessive processing load. The electronic device can possibly be made unable to be powered off or to return to a normal operation state in accordance with a certain procedure of a software control depending upon a symptom of the freezing state.

In order to deal with such a freezing state, e.g., a method is taken in some cases for removing a battery contained in the electronic device once so as to forcibly power off and solve the freezing state. The method is not advisable, though, as removal of the battery is not only troublesome but possibly causes a problem such as an erroneous insertion or a loss of the battery to be contained again in the electronic device.

Another conceivable method is to add a key switch for solving the freezing state to the electronic device, and to press the key switch so as to initialize the electronic device. The added key switch, however, causes space efficiency or easiness of operation to be degraded, and is not preferable in particular for a small-sized electronic device such as a portable electronic device.

It is ordinarily known to solve a freezing state by means of a control combined with a remote control means, as disclosed in, e.g., Japanese Patent Publication of Unexamined Applications (Kokai), No. 2006-109158. An electronic device that can be connected to a remote controller is disclosed in JP-A-2006-109158. The remote controller is provided with a sensing circuit which produces a resetting signal upon sensing operation members of an operation unit as being simultaneously pressed. The electronic device is provided in the main body with a resetting circuit which controls a power supply circuit in such a way that a CPU is reset upon the resetting signal being received. The remote controller and the main body of the electronic device is connected with each other through an exclusive resetting line for conducting the resetting signal produced by the sensing circuit to the resetting circuit.

The electronic device disclosed in JP-A-2006-109158 is, e.g., a remote controllable portable music player. If the main body freezes, the electronic device produces a resetting signal upon, e.g., three operation buttons of the remote controller being simultaneously pressed, so as to power off and initialize the CPU in the main body.

Thus, the related art disclosed in JP-A-2006-109158 has a problem in that it cannot be applied as it is to an electronic device that cannot be remote-controlled or provided with lots of operation buttons.

### SUMMARY OF THE INVENTION

Accordingly, an advantage of the present invention is to solve a freezing state of an electronic device only by using an indispensable key for an ordinary use.

To achieve the above advantage, one aspect of the present invention is to provide an electronic device including a power key, a time counter which measures how long the power key is continuously pressed, and first and second controllers. The first controller can be suspended while performing a software process upon identifying a length of time measured by the time counter as not being longer than a first given time length, and can be in control so that a power supply is turned off upon identifying the measured length of time as being longer than a second given time length which is longer than the first given time length and as not being longer than a third given time length which is longer than the second given time length. The second controller can send a resetting signal to the first controller upon identifying the measured length of time as being longer than the third given time length.

### BRIEF DESCRIPTION OF THE DRAWINGS

FIG. 1 is a perspective view for showing an appearance of a mobile communication terminal that is an electronic device of the embodiment of the present invention.

FIG. 2 is a block diagram for showing a configuration of the mobile communication terminal of the embodiment of the present invention.

FIG. 3 shows an example of a configuration and a connection of a second controller of the embodiment of the present invention.

### DETAILED DESCRIPTION OF THE INVENTION

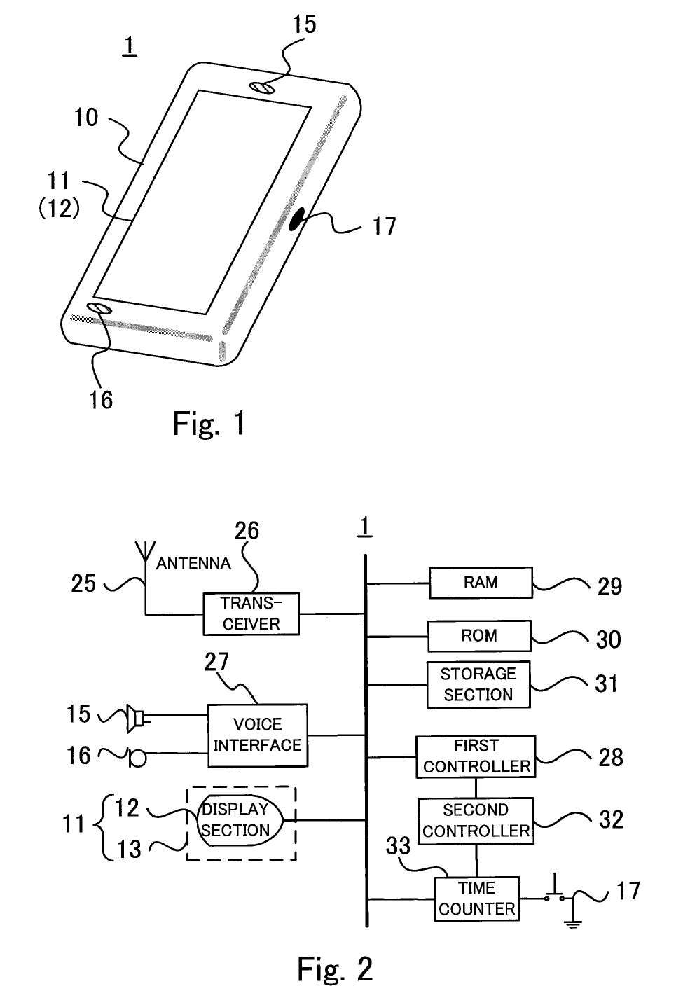

An embodiment of the present invention will be described with reference to FIGS. 1-3. In following descriptions, terms such as upper, lower, left, right, horizontal or vertical used while referring to a drawing shall be interpreted on a page of the drawing unless otherwise noted. In the drawings, like reference numerals refer to like members or portions.

FIG. 1 is a perspective view for showing an appearance of a mobile communication terminal 1 that is an electronic device of the embodiment of the present invention. The mobile communication terminal 1 has a housing 10 shaped as a rectangle (that may include rounded corners as shown in FIG. 1) with a thickness and a touch panel 11 provided on a front face (that faces a user if the mobile communication terminal 1 is used) of the housing 10.

The touch panel 11 is constituted by a display section 12 described later overlaid with a tactile sensor made of transparent material. The touch panel 11 is configured to display software-controlled operation keys on a screen of the display unit 12 so as to be used as an input operation unit, and display various kinds of texts and images so as to be used as a display unit as well.

The housing 10 is provided with the display section 12 which constitutes the touch panel 11 described above. The display section 12 is formed by, e.g., a liquid crystal or organic electroluminescent (organic EL) device. The display section 12 can display a text or an image. The mobile communication terminal 1 can carry out an application accompanied by a display of a screen (e.g., sending and receiving emails, browsing websites, making and searching a directory, etc.) by using the display section 12.

The display section 12 is provided and overlaid with a tactile sensor 13 which is not shown. The tactile sensor 13 is made of transparent material, and is provided in such a way as to form a portion of the front face of the housing 10. The touch panel 11 is constituted by the display section 12 and the tactile sensor 13 combined with each other.

The housing 10 is provide on upper and lower portions with an earpiece 15 and a mouthpiece 16, respectively. The earpiece 15 and the mouthpiece 16 are fixed as being directed head-on on the front face of the mobile communication terminal 1. As being provided with the earpiece 15 and the mouthpiece 16, the mobile communication terminal 1 can be used for voice communication.

The mobile communication terminal 1 is provided on a side of the housing 10 with a power key 17. The power key 17 is operated so that the mobile communication terminal 1 is powered on or off, and is used for an operation described later as well.

FIG. 2 is a block diagram of the mobile communication terminal 1. The mobile communication terminal 1 is provided with an antenna 25 and a transceiver 26, and can transmit and receive electromagnetic waves to and from a base station of a mobile communication network which is not shown. The mobile communication terminal 1 is provided with a voice interface 27, a first controller 28, a random access memory (RAM) 29, a read only memory (ROM) 30, a storage section 31, a second controller 32 and a time counter 33.

The transceiver 26, the voice interface 27, the RAM 29, the ROM 30, the storage section 31, and the display section 12 and the tactile sensor 13 described earlier with reference to FIG. 1 are individually connected to the first controller 28 through, e.g., a common bus, and are observed and controlled by the first controller 28. The first controller 28 is constituted, e.g., by a single processing device such as a microprocessor or a combination of a plurality of chips. The first controller 28 is provided with an input terminal for a resetting signal.

The RAM 29 is a memory used by the first controller 28 in such a way that the first controller 28 reads and writes a required program or data from and into the RAM 29 as necessary so as to implement a function of the mobile communication terminal 1. The ROM 30 is a memory in which a program or data is written in advance. The storage section 31 is a nonvolatile storage device from and into which data can be read and written.

In case of voice communication, an encoded voice signal is sent from a person who is calling through the base station and is received through the antenna 25 by the transceiver 26, and undergoes processes for demodulation and error-correction. The voice signal is then decoded by the voice interface 27 and is reproduced through the earpiece 15. Further, a voice signal collected by the mouthpiece 16 is encoded by the voice interface 27, undergoes processes for error-correction encoding and modulation and is amplified on the transceiver 26, and then is transmitted through the antenna 25 to the base station. The first controller 28 controls the transceiver 26 and the voice interface 27 so as to carry out the voice communication.

In case of data communication, a data signal is sent from an opposite end through the base station and is received through the antenna 25 by the transceiver 26, and undergoes processes for demodulation and error-correction. The data signal is then provided to the first controller 28 so as to be written into the RAM 29 or the storage section 31 or displayed on the display section 12. Further, data entered through the touch panel 11 or read from the RAM 29 or the storage section 31 undergoes processes for error-correction encoding and modulation and is amplified on the transceiver 26, and then is transmitted through the antenna 25 to the base station.

The time counter 33 is connected to the power key 17, and can measure how long the power key 17 is continuously pressed. If the power key 17 is pressed while the mobile communication terminal 1 is being powered on and the first controller 28 is performing a software process, the first controller 28 compares the length of time for which the power key 17 is continuously pressed with a first given time length and a second given time length (the latter is longer than the former).

The first controller 28 can be in a suspended state if the length of time for which the power key 17 is continuously pressed is not longer than the first given time length. In that case, the first controller 28 suspends a process that is being performed and indicates the suspended state on the display section 12.

The first controller 28 can control the mobile communication terminal 1 so that the mobile communication terminal 1 is powered off if the length of time for which the power key 17 is continuously pressed is longer than the first given time length and not longer than a third given time length. Meanwhile, the first controller 28 can maintain a state of the process that is being performed.

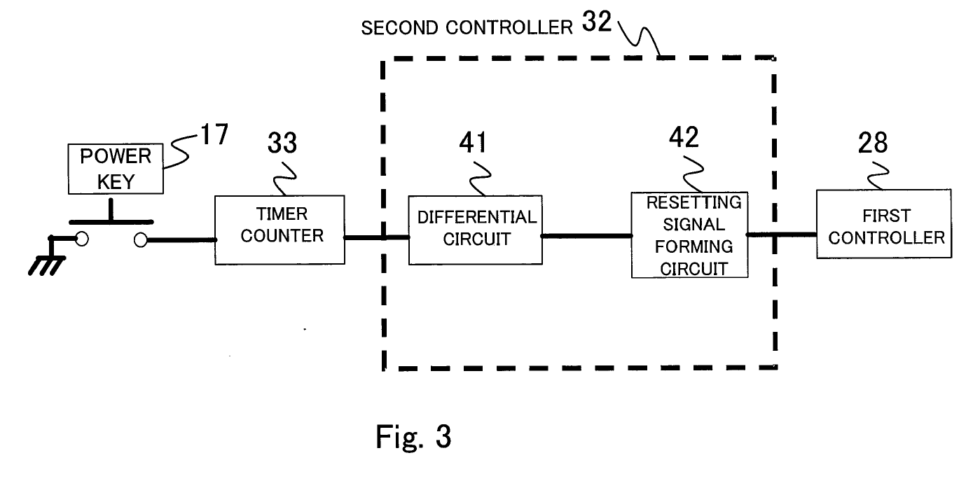

The second controller 32 is connected to the time counter 33 and the input terminal of the first controller 28 for a resetting signal. The second controller 32 and the time counter 33 are implemented only by hardware (FIG. 3 shows an example of a configuration and a connection of the second controller 32). The example of the second controller 32 shown in FIG. 3 is constituted by a differential circuit 41 and a resetting signal forming circuit 42. The differential circuit 41 receives a signal produced by the time counter 33 so as to produce a width of a change of the signal as an analog signal with respect to the change of the signal. The analog signal produced by the differential circuit 41 is converted into a digital signal by the resetting signal forming circuit 42 and is provided to the first controller 28.

If the first controller 28 has frozen owing to an excessive load, etc., the second controller 32 implemented only by hardware can send a resetting signal to the first controller 28 upon identifying the length of time measured by the time counter 33 for which the power key 17 is continuously pressed as being longer than the third given time length which is longer than the second given time length. The first controller 28 is initialized upon receiving the resetting signal, and can solve the freezing state.

According to the embodiment of the present invention, as the second controller 32 implemented by hardware is provided separately from the first controller 28 which performs a software process, a use of only the power key (which is indispensable for an ordinary use) can solve the freezing state of the electronic device by means of an operation for continuously pressing the power key for a period of time which is longer than the third given time length.

In the above description of the embodiment, conditions such as configurations, shapes, and connections of the mobile communication terminal, the touch panel, etc., and shapes and arrangements of the other materials should be considered as exemplary only, and thus may be variously modified within the scope of the present invention. For instance, the number of the housing(s) of the mobile communication terminal is not limited to one, and the present invention can be applied to an electronic device formed by movably connecting two or more housings.

The particular hardware or software implementation of the present invention may be varied while still remaining within the scope of the present invention. It is therefore to be understood that within the scope of the appended claims and their equivalents, the invention may be practiced otherwise than as specifically described herein.

What is claimed is:

1. An electronic device, comprising:
a power key;
a time counter adapted for measuring how long the power key is continuously pressed;
a first controller adapted for being suspended while performing a software process upon identifying a length of time measured by the time counter as not being longer than a first given time length, the first controller being in control so that a power supply is turned off upon identifying the measured length of time as being longer than a second given time length which is longer than the first given time length and as not being longer than a third given time length which is longer than the second given time length; and
a second controller adapted for sending a resetting signal to the first controller upon identifying the measured length of time as being longer than the third given time length.

2. The electronic device according to claim 1, wherein the second controller is implemented only by hardware.

3. The electronic device according to claim 1, wherein the second controller is constituted by a differential circuit and a resetting signal forming circuit.

4. The electronic device according to claim 1, wherein the second controller can send the resetting signal to the first controller upon the first controller being suspended so that the first controller returns to an initial state.

5. The electronic device according to claim 4, wherein the initial state equals a state that the first controller is in just after the electronic device is powered on.

6. A method for controlling an electronic device which includes a power key and a controller, comprising:
measuring how long the power key is continuously pressed;
making the controller suspended while a software process is being performed upon a measured length of time for which the power key is continuously pressed being identified as not being longer than a first given time length;
making the controller in control so that a power supply is turned off upon the measured length of time being identified as being longer than a second given time length which is longer than the first given time length and as not being longer than a third given time length which is longer than the second given time length; and
sending a resetting signal to the controller upon the measured length of time being identified as being longer than the third given time length.

7. The method for controlling the electronic device according to claim 6, wherein the resetting signal is sent only by means of hardware.

8. The method for controlling the electronic device according to claim 6, wherein the resetting signal is sent by means of a differential circuit and a resetting signal forming circuit.

9. The method for controlling the electronic device according to claim 6, wherein the resetting signal is sent to the controller upon the controller being suspended so that the controller returns to an initial state.

10. The method for controlling the electronic device according to claim 9, wherein the initial state equals a state that the controller is in just after the electronic device is powered on.
